(19) United States
(12) Patent Application Publication
(10) Pub. No.: US 2016/0040888 A1
(43) Pub. Date: Feb. 11, 2016

(54) Outdoor Torch

(71) Applicant: MSP Industries LLC, Cheshire, CT (US)

(72) Inventor: John W. CALDWELL, Cheshire, CT (US)

(21) Appl. No.: 14/820,764

(22) Filed: Aug. 7, 2015

Related U.S. Application Data
(60) Provisional application No. 62/034,316, filed on Aug. 7, 2014.

(51) Int. Cl. F24B 1/195; F21V 21/12; B65D 69/00; F21S 15/00

(52) U.S. Cl. CPC F24B 1/195; F21S 15/00; F21V 21/12; B65D 69/00; F21W 2131/10

(57) ABSTRACT

An outdoor torch and a kit for assembling an outdoor torch are provided. The outdoor torch includes a cradle for receiving a log, a first and second intermediate pipe, and a base pipe removably attached to an auger. The outdoor torch is interchangeable between multiple configurations and heights by arranging the cradle, first intermediate pipe, second intermediate pipe and base pipe in different configurations. The auger is drilled into the ground using an installation bar to securely plant the outdoor torch into the ground.

### CROSS-REFERENCE TO RELATED APPLICATIONS

The present application claims the benefit of U.S. Provisional Patent Application No. 62/034,316, filed on Aug. 7, 2014, which is hereby incorporated by reference in its entirety.

### FIELD OF THE INVENTION

The present invention relates to an outdoor lighting accessory that is used for burning a manufactured, synthetic, or composite fire log.

### BACKGROUND OF THE INVENTION

The present invention is directed to providing an improved outdoor lighting fixture that overcomes the shortcomings of those fixtures of the prior art. It is an object of the present invention to provide an outdoor torch that does not require the separate use of gas or oil for lighting the torch.

It is a further object of the invention to provide an outdoor torch that is portable and versatile, such that it can be assembled and disassembled with ease, and transported for use in different locations having different or the same ground surfaces.

It is a further object of the invention to provide an outdoor torch that is made from a durable material, such that the torch does not require replacement and can be weather resistant.

### SUMMARY OF THE INVENTION

In furtherance of the aforementioned objectives of the present invention, a unique and novel outdoor torch is provided.

In accordance with a first aspect of the invention, an outdoor torch is provided having a cradle configured to receive an ignitable log and comprising a cradle pipe extending from the base of the cradle. The outdoor torch also comprises a base pipe comprising a first open end and a second end, and an auger removably attached to the second end of the base pipe and configured to be drilled into a ground surface.

The outdoor torch according to the first aspect of the invention is configured to be interchangeable between a plurality of configurations having different heights. This includes a first configuration having a first height and comprising the cradle positioned on top of and secured to a first intermediate pipe by inserting the cradle pipe into a first open end of the first intermediate pipe. Further in the first configuration, the first intermediate pipe is positioned on top of and secured to a second intermediate pipe by inserting a dowel projecting from a second end of the first intermediate pipe into a first open end of the second intermediate pipe. The first configuration also includes the second intermediate pipe positioned on top of and secured to the base pipe by inserting a dowel projecting from a second end of the second intermediate pipe into the first open end of the base pipe.

The plurality of configurations of the outdoor torch of the first aspect of the invention also includes a second configuration having a second height. This second configuration includes the cradle positioned on top of and secured to the first intermediate pipe by inserting the cradle pipe into the first open end of the first intermediate pipe. The first intermediate pipe is positioned on top of and secured to the base pipe by inserting the dowel of the first intermediate pipe into the first open end of the base pipe.

A third configuration having a third height is also provided, in which the cradle is positioned on top of and secured to the base pipe by inserting the cradle pipe into the first open end of the base pipe.

The outdoor torch according to the first aspect of the invention further comprises an installation bar configured to be inserted perpendicular to the base pipe through opposing openings in the base pipe. The auger is configured to be drilled into the ground surface for planting the outdoor torch by inserting the installation bar through the opposing openings in the base pipe and rotating the installation bar to drill the auger.

In a further embodiment of the outdoor torch according to the first aspect of the invention, the cradle comprises an elongated and U-shaped receptacle configured to hold the ignitable log. The cradle receptacle may comprise a platform configured to support the ignitable log. The cradle receptacle may comprise two end walls on opposing sides of the U-shaped receptacle with each end wall having a slot at a base of the end wall to allow for air and fluid flow beneath the platform.

In accordance with a second aspect of the invention, a kit for assembling an outdoor torch is provided. The kit includes a cradle configured to receive an ignitable log and having a cradle pipe extending from the base of the cradle, a first and second intermediate pipe each having a first open end and a second end comprising a dowel, a base pipe having a first open end and a second end, an auger configured to be removably attached to the second end of the base pipe, and an installation bar configured to be inserted perpendicular to the base pipe through opposing openings in the base pipe.

According to an embodiment of the kit of the second aspect of the invention, the first open end of the first intermediate pipe, the first open end of second intermediate pipe and the first open end of the base pipe each have a first and same outer diameter. The cradle pipe, the dowel of the first intermediate pipe and the dowel of the second intermediate pipe each have a second and same outer diameter, which is less than the first outer diameter. The first intermediate pipe and the second intermediate pipe may have different lengths.

According to a further embodiment of the kit of the second aspect of the invention, the outdoor torch can be assembled into a plurality of configurations having different heights. This includes a first configuration having a first height. In the first configuration, the cradle is positioned on top of and secured to the first intermediate pipe by inserting the cradle pipe into the first open end of the first intermediate pipe. The first intermediate pipe is positioned on top of and secured to the second intermediate pipe by inserting the dowel of the first intermediate pipe into the first open end of the second intermediate pipe. The second intermediate pipe is positioned on top of and secured to the base pipe by inserting the dowel of the second intermediate pipe into the first open end of the base pipe, and the base pipe is secured to the auger.

The plurality of configurations also includes a second configuration having a second height. In the second configuration, the cradle is positioned on top of and secured to the first intermediate pipe by inserting the cradle pipe into the first open end of the first intermediate pipe. The first intermediate pipe is positioned on top of and secured to the base pipe by inserting the dowel of the first intermediate pipe into the first open end of the base pipe, and the base pipe secured to the auger.

The plurality of configurations also comprises a third configuration having a third height. In the third configuration, the cradle is positioned on top of and secured to the base pipe by inserting the dowel of the first intermediate pipe into the first open end of the base pipe, and the base pipe secured to the auger.

According to a further embodiment of the kit of the second aspect of the invention, the auger is configured to be attached to the base pipe and drilled into a ground surface for planting the outdoor torch by inserting the installation bar through the opposing openings in the base pipe and rotating the installation bar to drill the auger.

According to an embodiment of the kit of the second aspect of the invention, the cradle comprises an elongated and U-shaped receptacle configured to hold the ignitable log. The cradle receptacle may comprise a platform configured to support the ignitable log, which can be perforated. The cradle receptacle may comprise two end walls on opposing sides of the U-shaped receptacle, and each end wall can comprise a slot at the base of the end wall to allow for air and fluid flow beneath the platform.

In one embodiment of the kit of the second aspect of the invention, the cradle, the first intermediate pipe, the second intermediate pipe and the base pipe are made from cold rolled steel and the auger is made from aluminum.

According to a further embodiment of the kit of the second aspect of the invention, the kit further includes a flat base configured to be removably attached to the second end of the base pipe.

### BRIEF DESCRIPTION OF THE FIGURES

FIG. 1 shows an embodiment of the outdoor torch according to an embodiment of the invention.

FIG. 2A shows an embodiment of a base pipe and auger of the outdoor torch according to an embodiment of the invention.

FIG. 2B shows an embodiment of a first intermediate pipe of the outdoor torch according to an embodiment of the invention.

FIG. 2C shows an embodiment of a second intermediate pipe of the outdoor torch according to an embodiment of the invention.

FIG. 2D shows an embodiment of a base pipe and auger of the outdoor torch according to an embodiment of the invention.

FIG. 2E shows an embodiment of an installation bar of the outdoor torch according to an embodiment of the invention.

FIG. 3A shows a first, side view of a cradle of the outdoor torch according to an embodiment of the invention.

FIG. 3B shows a second, side view of a cradle of the outdoor torch according to an embodiment of the invention.

FIG. 3C shows a top-side view of a cradle of the outdoor torch according to an embodiment of the invention.

FIG. 3D shows a perspective view of a cradle of the outdoor torch according to an embodiment of the invention, comprising a log.

FIG. 4A shows an exploded view of a first configuration of the outdoor torch and a method for assembling the same according to an embodiment of the invention.

FIG. 4B shows an exploded view of a second configuration of the outdoor torch and a method for assembling the same according to an embodiment of the invention.

FIG. 4C shows an exploded view of a third configuration of the outdoor torch and a method for assembling the same according to an embodiment of the invention.

### DETAILED DESCRIPTION OF THE FIGURES

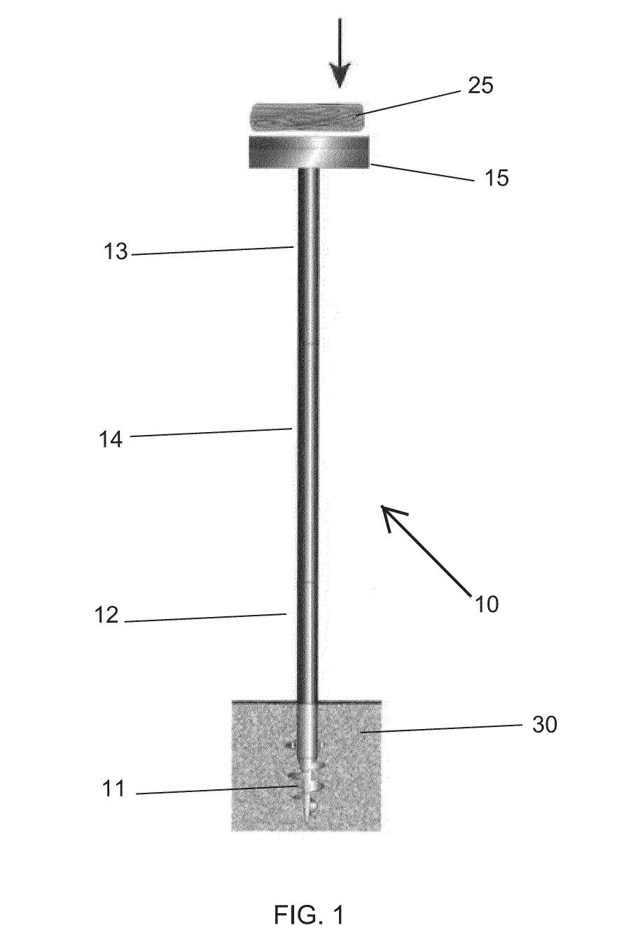

The outdoor torch of the present invention will now be described with reference made to FIGS. 1-4.

An outdoor torch 10 according to the present invention is provided and shown in FIG. 1, which can include multiple components that are configured for attachment to form a torch 10 configured to hold an ignitable log 25 and have an adjustable height.

In an embodiment of the torch 10 shown in FIG. 1, the torch 10 includes an auger 11 at its base that is configured to be drilled into the ground 30 for securely planting the torch 10 in an outdoor environment. The auger 11 is removably attached to a base pipe 12 by, for example, inserting a bolt 16a through aligning pairs of openings in the auger 11 and base pipe 12 and securing a nut 16b over the bolt 16a. A first intermediate pipe 14 is inserted into and attached to the base pipe 12 and a second intermediate pipe 13 is inserted into and attached to the first intermediate pipe 14. A cradle 15 for receiving and holding a log 25 is inserted into and attached to the second intermediate pipe 13.

The torch 10 according to the invention can be provided in the form of a kit comprising the multiple components that can be assembled into different torch configurations.

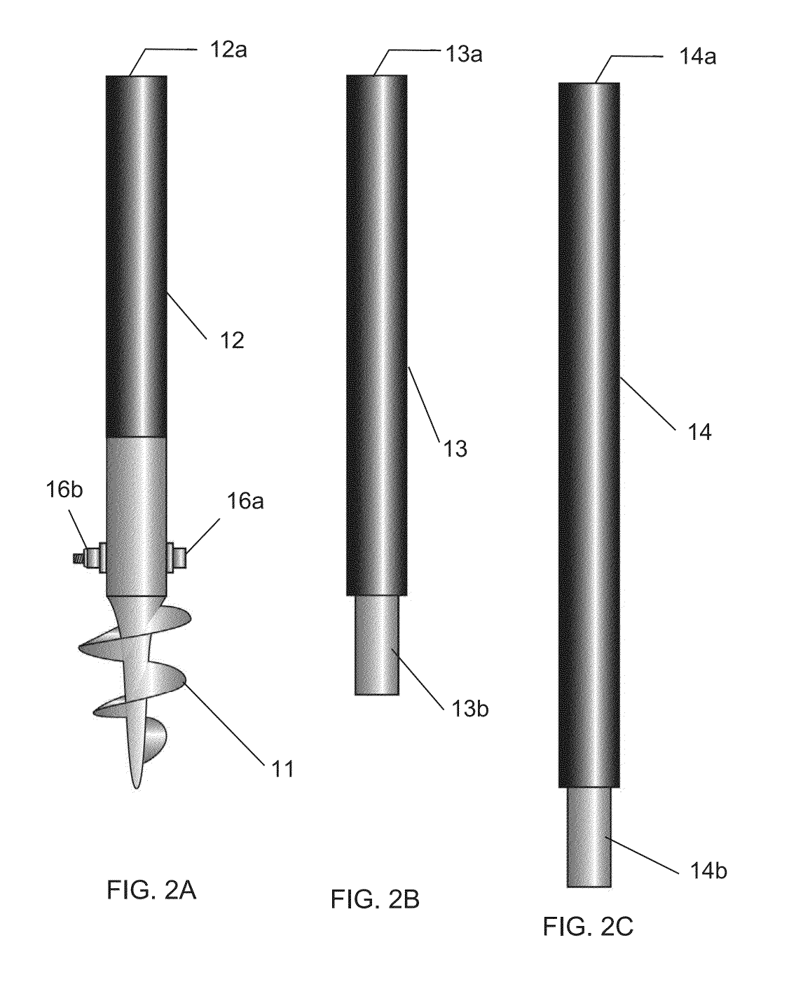

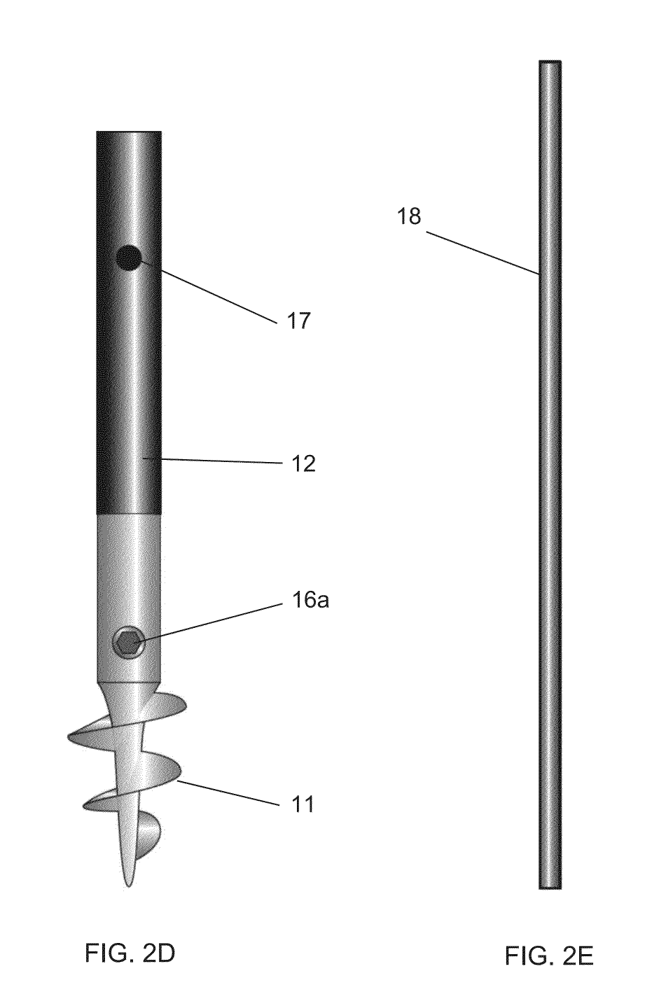

The base pipe 12 is provided, which has the auger 11 attached, and shown for example in FIGS. 2A and 2D. In a preferred embodiment, the auger 11 is made from aluminum and the base pipe 12 is made from cold rolled steel. The auger 11 can be configured to be inserted into the base of the base pipe 12, and a bolt 16a inserted through overlapping holes in the auger 11 and base pipe 12 and secured by a nut 16b, in order to securely attach the auger 11 to the base pipe 12. The end 12a of the base pipe 12 opposite the auger 11 includes an opening for receiving a further pipe. The base pipe 12 is also provided with a pair of opposing holes 17 that are dimensioned for receiving an installation bar 18, shown in FIG. 2E. When inserted into the base pipe 12, the installation bar 18 allows a user to rotate the base pipe 12 and attached auger 11, to drill the auger 11 into the ground 30 for planting the base pipe 12 and torch 10. In a preferred embodiment, the installation bar 18 is made from steel. In a preferred embodiment, the base pipe 12 may have a length of approximately twenty-four inches and the auger 11 may have a length of approximately seven inches. The installation bar 18 can be approximately twenty-four inches in length with a diameter of 0.5 inches.

Two intermediate pipes 13 and 14, shown for example in FIGS. 2B and 2C, are also provided for optionally including in the torch 10 assembly. The intermediate pipes 13 and 14 can have different lengths, as shown in FIGS. 2B and 2C, or can be of the same length. Dowels 13b and 14b are attached at an end of each of the intermediate pipes 13 and 14. The dowels 13b and 14b are dimensioned for inserting into the open ends 13a or 14a of an intermediate pipe 13 or 14, or the open end 12a of the base pipe 12, to achieve the desired height of the torch 10. In a preferred embodiment, the intermediate pipes 13 and 14 may have an outer diameter of two inches and an inner diameter of one and three-quarters inches. In the embodiment shown in the Figures, the first intermediate pipe 14 may have a length of twenty-one inches and the second intermediate pipe 13 may have a length of twenty-four inches. The dowels 13b and 14b can have a length of approximately four inches, and the outer diameter of the dowels 14b and 14b is less than the inner diameter of the open ends 12a, 13a and 14a of the base pipe 12 and intermediate pipes 13 and 14. The intermediate pipes 13 and 14 are preferably made from cold rolled steel.

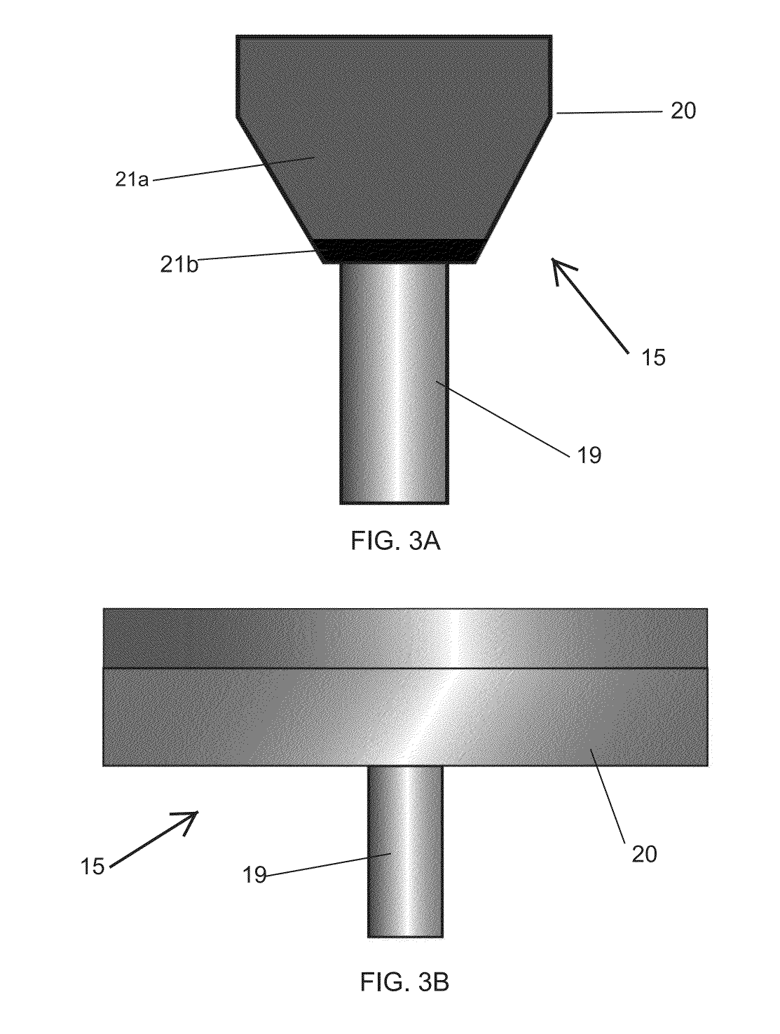

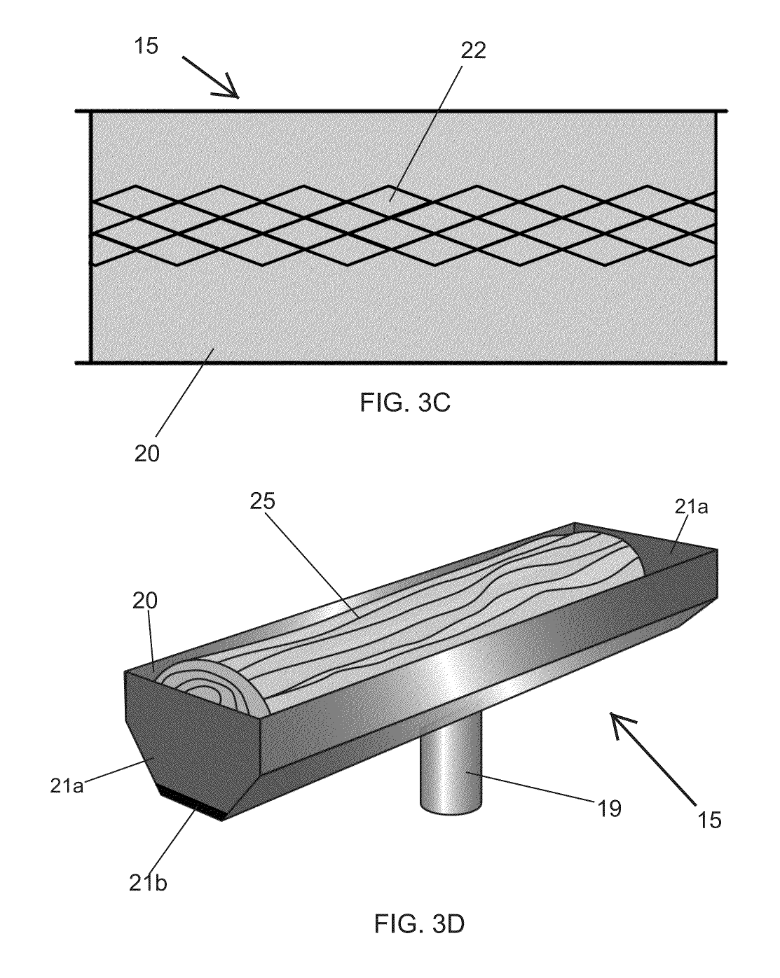

The torch 10 further includes a cradle 15, shown in FIGS. 3A-3D, which holds a log 25 that is lit in the torch 10. A cradle pipe 19 is attached to the base of the cradle 15, and is dimensioned into inserting into any of the open ends 12a, 13a or 14a of the base pipe 12 or intermediate pipes 13 or 14. The cradle 15 includes a receptacle 20 that is dimensioned for holding a log 25. On each end of the receptacle 20, an end wall 21a is provided, and a slot 2 b is provided at the base of each end wall 21a. A platform 22 is provided within the receptacle 20, on top of which a log 25 can be placed. In an embodiment as shown in FIG. 3C, the platform 22 can be perforated or have a mesh configuration. The slots 21b in the receptacle 20 allow for the flow of air through the receptacle 20 beneath the platform 22 and log 25. After using the torch 10, any ash or residue from the log 25 that falls through the platform 22 can be flushed out through the slots 21b of the receptacle 22 with water or rain. In an alternate embodiment, the receptacle 20 can be an elongated, U-shaped structure with entirely open ends (i.e., without end walls 21a). In an exemplary embodiment, the receptacle 20 of the cradle 15 may have dimensions of 15.5 inches by 6.5 inches, with a depth of four inches. In a preferred embodiment, the cradle 15 is made from cold rolled steel.

The torch 10 can be assembled in multiple different size configurations depending on which of the components are incorporated in its assembly. Because the each of the base pipe 12, first intermediate pipe 14, and second intermediate pipe 13 have open ends 12a, 13a and 14a having substantially the same diameter, each of the open ends 12a, 13a and 14a are configured to receive any of the dowels 13b, 14b from the intermediate pipes 13 and 14, or the cradle pipe 19, each of which also have substantially the same diameter as each other. The diameter of the open ends 12a, 13a, 14a is greater than the diameter of the dowels 13b, 14b and cradle pipe 19. Thus, the height of the torch 10 can be adjusted by incorporating different combinations of the components of the torch 10.

A first, maximum height can be provided by combining base pipe 12, the first intermediate pipe 14 and the second intermediate pipe 13, with the cradle 15. Two intermediate heights can be provided by using the base pipe 12 with either of the intermediate pipes 13 or 14, each having different lengths, with the cradle 15. A fourth, lesser height of the torch 10 can be provided, in which the cradle 15 attaches to the base pipe 12 only. This size would be ideal for small open fire in a small area.

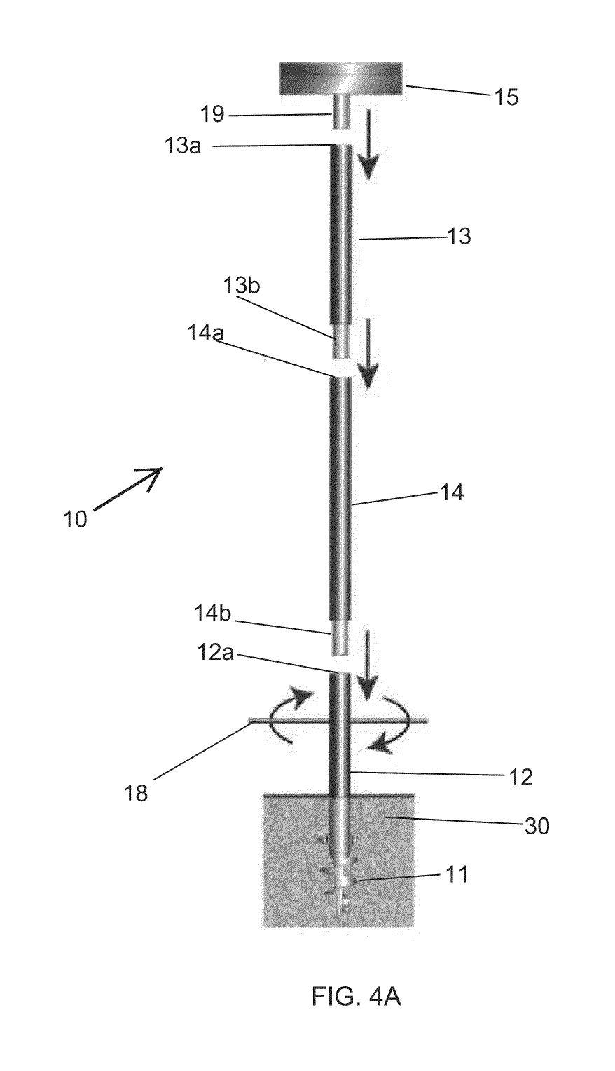

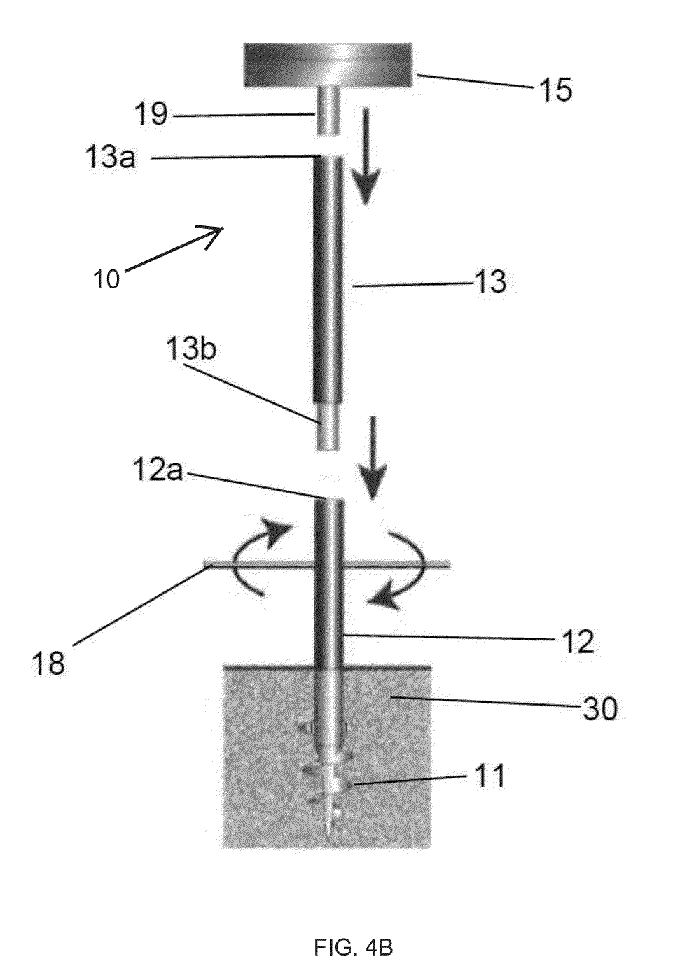

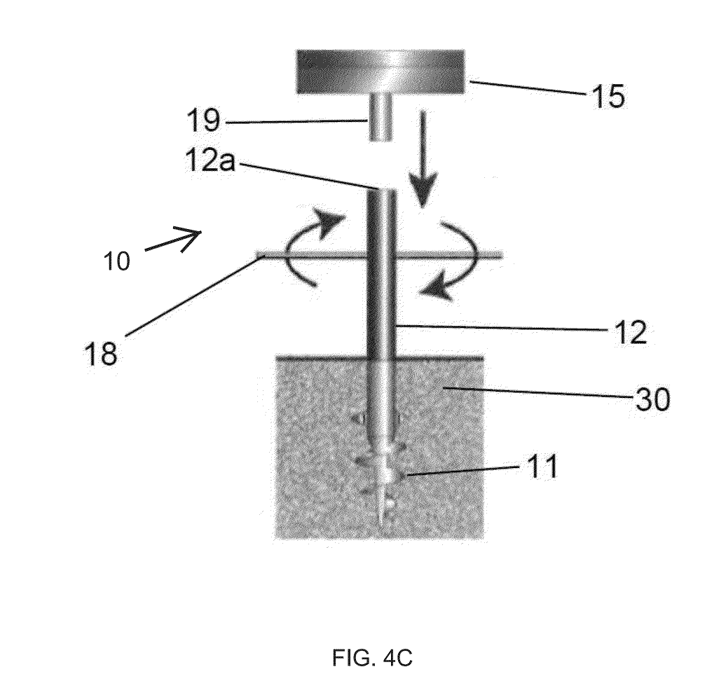

A method for installing the torch 10 according to the invention is shown in FIGS. 4A. A first configuration of the torch is shown in FIG. 4A. First, in order to securely plant the torch 10 into the ground, the installation bar 18 is inserted through the base pipe 12. Once a desirable location in the ground 30 is located, the auger 11 affixed to the base pipe 12 is drilled into the ground 30 by turning the installation bar 18. The auger 11 and base pipe 12 are preferably drilled between twelve and fourteen inches into the ground 30 to maintain proper stability of the torch 10. The base pipe 12 can be provided with an external marker or indicator to show the proper depth for installation. For example, as shown in the Figures, the base pipe 12 may be painted in a two-tone manner, wherein the line between colors marks the proper installation depth on the base pipe 12. With the base pipe 12 and auger 11 securely planted in the ground 30, the installation bar 18 can be removed from the base pipe 12 and the rest of the components of the torch 10 can be added to the assembly. During periods of non-use, the removed installation bar 18 can be inserted into base pipe 12, which is hollow, and stored in the torch 10, if the torch 10 is assembled with a height sufficient to accommodate the length of the installation bar 18. In the embodiment shown in FIG. 4A, the torch 10 has the maximum height offered by the available components. The first intermediate pipe 14 is attached to the base pipe 12 by inserting the dowel 14b of the first intermediate pipe 14 into the open end 12a of the base pipe. The second intermediate pipe 13 is attached to the first intermediate pipe 14 by inserting the dowel 13b of the second intermediate pipe 13 into the open end 14b of the first intermediate pipe 14. The cradle 15 is attached to the first intermediate pipe 13 by inserting the cradle pipe 19 into the open end 13b of the second intermediate pipe 13. The torch 10 can be disassembled by performing the above-described steps in reverse and detaching the respective pipe connections. The torch 10 can be moved and installed at another location.

The torch 10 can also be assembled into alternate configurations using the same components, as shown in FIGS. 4B and 4C. In the configuration shown in FIG. 4B, the height of the torch 10 is reduced by omitting the first intermediate pipe 14. In the configuration shown in FIG. 4C, the height of the torch is 10 further reduced by omitting both intermediate pipes 13 and 14.

In a further embodiment of the invention, the base pipe 12 can be detached from the auger 11 by removing the bolt 16a and nut 16b. In its place, a flat base (not shown) can be inserted into the base of the base pipe 12 and attached to the base pipe 12 using the same bolt 16a and nut 16b. This allows the user of the torch 10 to use the torch 10 on surfaces where the ground 30 is too hard for the auger 11 to drill through. The flat base can be removed from the base pipe 12 and the auger 11 reattached.

In a preferred embodiment, the torch 10 is made for burning manufactured, synthetic, or composite fire logs, including logs that have insect-repellant properties. The pipes 12, 13 and 14 and the cradle 15 are preferably made from cold rolled steel, but can also be made from other materials, such as cast iron.

The elements of the torch 10 are not limited to the particular dimensions indicated above, but can be varied in alternative embodiments of the inventions. It should be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein and thereto without departing from the spirit and scope of the present invention.

What is claimed:

1. A kit for assembling an outdoor torch, comprising:
a cradle configured to receive an ignitable log and comprising a cradle pipe extending from the base of the cradle;
a first intermediate pipe;
a second intermediate pipe, each of the first and second intermediate pipes comprising a first open end and a second end comprising a dowel;
a base pipe comprising a first open end and a second end;
an auger configured to be removably attached to the second end of the base pipe; and
an installation bar configured to be inserted perpendicular to the base pipe through opposing openings in the base pipe.

2. The kit according to claim 1, wherein the first open end of the first intermediate pipe, the first open end of second intermediate pipe and the first open end of the base pipe each have a first and the same outer diameter.

3. The kit according to claim 2, wherein the cradle pipe, the dowel of the first intermediate pipe and the dowel of the second intermediate pipe each have a second and the same outer diameter, which is less than the first outer diameter.

4. The kit according to claim 3, wherein the first intermediate pipe and the second intermediate pipe have different lengths.

5. The kit according to claim 4, wherein the outdoor torch can be assembled into a plurality of configurations having different heights, including a first configuration having a first height and comprising:
the cradle positioned on top of and secured to the first intermediate pipe by inserting the cradle pipe into the first open end of the first intermediate pipe;
the first intermediate pipe positioned on top of and secured to the second intermediate pipe by inserting the dowel of the first intermediate pipe into the first open end of the second intermediate pipe;
the second intermediate pipe positioned on top of and secured to the base pipe by inserting the dowel of the second intermediate pipe into the first open end of the base pipe; and
the base pipe secured to the auger.

6. The kit according to claim 5, wherein the plurality of configurations comprises a second configuration having a second height and comprising:
the cradle positioned on top of and secured to the first intermediate pipe by inserting the cradle pipe into the first open end of the first intermediate pipe;
the first intermediate pipe positioned on top of and secured to the base pipe by inserting the dowel of the first intermediate pipe into the first open end of the base pipe; and
the base pipe secured to the auger.

7. The kit according to claim 6, wherein the plurality of configurations comprises a third configuration having a third height and comprising:
the cradle positioned on top of and secured to the base pipe by inserting the cradle pipe into the first open end of the base pipe; and
the base pipe secured to the auger.

8. The kit according to claim 1, wherein the auger is configured to be attached to the base pipe and drilled into a ground surface for planting the outdoor torch by inserting the installation bar through the opposing openings in the base pipe and rotating the installation bar to drill the auger.

9. The kit according to claim 1, wherein the cradle comprises an elongated and U-shaped receptacle configured to hold the ignitable log.

10. The kit according to claim 9, wherein the cradle receptacle comprises a platform configured to support the ignitable log.

11. The kit according to claim 10, wherein the cradle receptacle comprises two end walls on opposing sides of the U-shaped receptacle, and wherein each end wall comprises a slot at a base of the end wall to allow for air and fluid flow beneath the platform.

12. The kit according to claim 11, wherein the cradle platform is perforated.

13. The kit according to claim 1, wherein the cradle, the first intermediate pipe, the second intermediate pipe and the base pipe are made from cold rolled steel.

14. The kit according to claim 1, wherein the auger is made from aluminum.

15. The kit according to claim 1, further comprising a flat base configured to be removably attached to the second end of the base pipe.

16. An outdoor torch comprising:
a cradle configured to receive an ignitable log and comprising a cradle pipe extending from the base of the cradle;
a base pipe comprising a first open end and a second end; and
an auger removably attached to a second end of the base pipe configured to be drilled into a ground surface;
wherein the outdoor torch is configured to be interchangeable between a plurality of configurations having different heights, including:
a first configuration having a first height and comprising:
the cradle positioned on top of and secured to a first intermediate pipe by inserting the cradle pipe into a first open end of the first intermediate pipe;
the first intermediate pipe positioned on top of and secured to a second intermediate pipe by inserting a dowel projecting from a second end of the first intermediate pipe into a first open end of the second intermediate pipe; and
the second intermediate pipe positioned on top of and secured to the base pipe by inserting a dowel projecting from a second end of the second intermediate pipe into the first open end of the base pipe;
a second configuration having a second height and comprising:
the cradle positioned on top of and secured to the first intermediate pipe by inserting the cradle pipe into the first open end of the first intermediate pipe; and
the first intermediate pipe positioned on top of and secured to the base pipe by inserting the dowel of the first intermediate pipe into the first open end of the base pipe; and
a third configuration having a third height and comprising:
the cradle positioned on top of and secured to the base pipe by inserting the cradle pipe into the first open end of the base pipe.

17. The outdoor torch according to claim 16, further comprising:
an installation bar configured to be inserted perpendicular to the base pipe through opposing openings in the base pipe; and
wherein the auger is configured to be drilled into the ground surface for planting the outdoor torch by inserting the installation bar through the opposing openings in the base pipe and rotating the installation bar to drill the auger.

18. The outdoor torch according to claim 16, wherein the cradle comprises an elongated and U-shaped receptacle configured to hold the ignitable log.

19. The outdoor torch according to claim 18, wherein the cradle receptacle comprises a platform configured to support the ignitable log.

20. The outdoor torch according to claim 19, wherein the cradle receptacle comprises two end walls on opposing sides of the U-shaped receptacle, and wherein each end wall comprises a slot at a base of the end wall to allow for air and fluid flow beneath the platform.
